(19) United States
(12) Patent Application Publication
(10) Pub. No.: US 2006/0176812 A1
(43) Pub. Date: Aug. 10, 2006

(54) Data-driven-type information processor outputting data packet to be processed at prescribed interval and method of controlling the same

(75) Inventor: Kohichi Hatakeyama, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/347,374

(22) Filed: Feb. 6, 2006

(30) Foreign Application Priority Data
Feb. 8, 2005 (JP) 2005-031427

(51) Int. Cl. H04L 12/56; H04L 12/26; H04L 12/28; H04L 1/00

(52) U.S. Cl. 370/229; 370/395.4

(57) ABSTRACT

When a data packet branch unit determines that a data packet is included in a data packet group of which output at a prescribed interval is demanded, a data packet status acquiring unit acquires historical information of another data packet included in the data packet group by referring to a data memory, determines a waiting time of the data packet, and stores the waiting time in the data memory. An output data packet generation unit outputs the data packet after the waiting time stored in the data memory has elapsed. Therefore, variation in an amount of processing of the data packets within a data-driven-type information processor is reduced and software design in which margin is reduced almost to the limit of processing performance can be made.

This nonprovisional application is based on Japanese Patent Application No. 2005-031427 filed with the Japan Patent Office on Feb. 8, 2005, the entire contents of which are hereby incorporated by reference.

### FIELD OF THE INVENTION

The present invention relates to a data-driven-type information processor capable of parallel processing by performing operational processing along with input/output of a data packet, and more particularly to a data-driven-type information processor capable of efficient and high-speed operational processing by outputting a data packet to be processed at a constant interval or at a designated interval as well as to a method of controlling the same.

### DESCRIPTION OF THE BACKGROUND ART

Recently, improvement in processor performance has increasingly been demanded in various fields, such as multimedia processing or high-definition image processing in which high-speed processing of a large amount of data is demanded. In current LSI (Large Scale Integrated circuit) manufacturing technology, however, a speed of a device is limited. Under such circumstances, parallel processing has attracted attention, and research and development for the same has vigorously been conducted.

In particular, a data-driven-type architecture has attracted attention among computer architectures suitable for parallel processing. In a data-driven-type processing scheme, the processing proceeds in parallel under the rule that “the processing is performed when all input data necessary for certain processing are available and resources such as an operation unit necessary for that processing are allocated.”

FIG. 1 is a block diagram showing a schematic configuration of a conventional data-driven-type information processor. In the data-driven-type information processor, a merge unit 116, a program storage unit 111, a queue unit 112, an operational processing unit 113, and a branch unit 114 are connected to form a loop through a go-around pipeline 117.

Merge unit 116 rearranges data packets input through a data packet input portion 118 in a prescribed order and sends them to program storage unit 111. Program storage unit 111 adds a necessary operation instruction and a node number to the data packet received from merge unit 116, generates a data packet constituted of prescribed bit fields, and sends the data packet to queue unit 112.

Upon receiving the data packet from program storage unit 111, queue unit 112 waits until two data packets to be operated are ready. As soon as the data packets are ready, the data packets are sent to operational processing unit 113.

Operational processing unit 113 performs operation such as arithmetic operation or logical operation on data included in the two data packets, in response to an operation instruction included in the data packet received from queue unit 112. Thereafter, operational processing unit 113 causes a result of operation to be stored in the data packet provided with a destination node number, and sends the data packet to branch unit 114.

Branch unit 114 determines the destination in accordance with the destination node number added to the data packet received from operational processing unit 113, and distributes the data packets. Specifically, if the data packet is directed to another data-driven-type information processor, the data packet is sent through a data packet output portion 119. Alternatively, the data packet is directed to its own data-driven-type information processor, the data packet is sent to merge unit 116 through a pipeline 115.

The invention disclosed in Japanese Patent Laying-Open No. 2002-189710 relates to the above-described technique. FIG. 2 is a block diagram showing a schematic configuration of an overflow avoidance device for a data-driven-type processor disclosed in Japanese Patent Laying-Open No. 2002-189710. The overflow avoidance device is configured by adding a delay instruction processing block 127 to the configuration of the conventional data-driven-type information processor shown in FIG. 1.

Delay instruction processing block 127 is connected to go-around pipeline 117 coming from merge unit 116 shown in FIG. 1 through an input portion 121, and connected to program storage unit 111 and go-around pipeline 117 on its output side through an output portion 126.

FIG. 3 is a block diagram showing details of delay instruction processing block 127. Delay instruction processing block 127 includes an instruction fetch unit 122, a memory 123 for delay token storage, a timer 124 for delay processing, and a delay instruction processing unit 125 arranged around program storage unit 111.

Upon receiving a data packet containing a delay instruction, instruction fetch unit 122 sends delay time data representing a parameter of the delay instruction to delay instruction processing unit 125, along with a data packet containing an instruction that is fetched subsequent to the delay instruction.

Memory 123 for delay token storage stores the instruction fetched subsequent to the delay instruction. In addition, timer 124 for delay processing counts a delay time based on the delay time data. Delay instruction processing unit 125 takes out the instruction from memory 123 for delay token storage after the delay time counted by timer 124 for delay processing has elapsed, and sends the instruction to go-around pipeline 117. In this manner, the data packet containing the instruction that is fetched subsequent to the delay instruction is delayed by a prescribed time, so that the number of data packets transmitted simultaneously to go-around pipeline 117 can be reduced and overflow on go-around pipeline 117 can be avoided.

FIG. 4 illustrates static analysis of a flow graph disclosed in Japanese Patent Laying-Open No. 2002-189710. In the flow graph, instruction nodes that can simultaneously be executed among instruction nodes of a program are arranged horizontally in each rank, rearranged from top to bottom in the order of execution, and provided with a node number in the order of execution. In the flow graph shown in FIG. 4, the number of tokens in rank 3 and rank 4 is set to 5, which is not smaller than the upper limit of 4. Accordingly, the number of data packets simultaneously transmitted to go-around pipeline 117 in response to the above-described delay instruction is reduced, so that overflow on go-around pipeline 117 is avoided.

The static analysis in the flow graph described above assumes that the data packet goes around the data-driven-type information processor at a constant interval. On the other hand, variation due to various factors takes place, with regard to an actual interval of output of data packets within the data-driven-type information processor. The factors in variation in the output interval include deviation in timing of output due to micro time difference during waiting of data packets, disturbance in the flow of the data packets caused by change in an operation of the data packet due to conditional branching in the data flow graph, variation in the interval of output of the data packets caused by duplication or disappearance of the data packet, and the like.

Variation in the output interval in terms of time causes no problem, provided that it can be accommodated in processing capability of the data-driven-type information processor. In many cases, however, the data-driven-type information processor is operated around its processing performance limit. In such a case, if variation is significant, the number of data packets on the pipeline instantaneously increases and the processing capability of the data-driven-type information processor is exceeded, which results in suspension of the data-driven-type information processor.

In order to avoid such a situation, software is generally designed such that some margin is secured for maximum processing performance of the data-driven-type information processor in static analysis of the flow graph. With such design, however, the processing performance of the data-driven-type information processor cannot sufficiently be utilized, and performance has been made poorer.

### SUMMARY OF TH INVENTION

An object of the present invention is to provide a data-driven-type information processor allowing software design in which margin is reduced almost to the limit of processing performance.

According to one aspect of the present invention, a data-driven-type information processor performing operational processing along with input/output of a data packet includes: a control unit determining a waiting time required for the data packet when the data packet is included in a data packet group of which output at a prescribed interval is demanded and outputting the data packet when the waiting time has elapsed; and an operational processing unit performing operational processing in response to an operation instruction included in the data packet.

Accordingly, variation in an amount of processing of the data packet within the data-driven-type information processor is reduced, and software design in which margin is reduced almost to the limit of processing performance can be made.

Preferably, the control unit includes a branch unit determining whether the data packet is included in the data packet group of which output at the prescribed interval is demanded and distributing the data packet in accordance with a result of determination, an acquiring unit acquiring historical information of another data packet included in the data packet group when the data packet is included in the data packet group of which output at the prescribed interval is demanded and determining a waiting time of the data packet, a storage unit storing the waiting time determined by the acquiring unit, an output portion outputting the data packet when the waiting time stored in the storage unit has elapsed, and a merge unit causing the data packet that has been determined by the branch unit as not included in the data packet group of which output at the prescribed interval is demanded, the data packet that has been determined by the acquiring unit as not having to wait, and the data packet output from the output portion, to merge.

When the data packet is included in the data packet group of which output at the prescribed interval is demanded, the acquiring unit acquires the historical information of another data packet included in the data packet group and determines a waiting time of the data packet. Therefore, the data packet included in the data packet group can accurately be output at a prescribed interval.

Preferably, the data packet group refers to a plurality of data packets containing identical destination information.

Accordingly, whether or not the data packet is included in the data packet group can readily be determined by referring to the destination information of the data packet.

Preferably, the branch unit holds in a register, the destination information included in a data packet containing a prescribed instruction, and determines whether the data packet is included in the data packet group, based on whether the destination information of the data packet is identical to the destination information held in the register.

Accordingly, setting of the data packet group can readily be made.

Preferably, the prescribed interval is included in the data packet containing the prescribed instruction.

Therefore, the interval can readily be changed.

Preferably, the prescribed interval is a constant interval.

Therefore, an effort for setting the interval can be obviated.

Preferably, if there are a plurality of data packet groups, the output portion outputs the plurality of data packet groups in a prescribed order.

Therefore, execution of the instruction, for which the order of arrival of the data has been determined, can readily be performed.

Preferably, the output portion outputs data packets included in the data packet group sequentially from a data packet having a smaller generation number.

Therefore, the order of execution of the instruction can readily be controlled.

Preferably, the data packet includes a flag indicative of whether the data packet is included in the data packet group of which output at the prescribed interval is demanded. The acquiring unit determines whether the data packet is included in the data packet group of which output at the prescribed interval is demanded, by referring to the flag.

Therefore, determination can readily be made.

According to another aspect of the present invention, a method of controlling a data-driven-type information processor performing operational processing along with input/output of a data packet includes the steps of: determining a waiting time required for the data packet when the data packet is included in a data packet group of which output at a prescribed interval is demanded and outputting the data packet when the waiting time has elapsed; and performing operational processing in response to an operation instruction included in the data packet.

Preferably, the step of determining a waiting time and outputting the data packet includes the steps of: determining whether the data packet is included in the data packet group of which output at the prescribed interval is demanded and distributing the data packet in accordance with a result of determination, acquiring historical information of another data packet included in the data packet group when the data packet is included in the data packet group of which output at the prescribed interval is demanded and determining a waiting time of the data packet, storing the determined waiting time, outputting the data packet when the stored waiting time has elapsed, and causing the data packet that has been determined as not included in the data packet group of which output at the prescribed interval is demanded, the data packet that has been determined as not having to wait, and the output data packet, to merge.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a conventional data-driven-type information processor.

FIG. 2 is a block diagram showing a schematic configuration of an overflow avoidance device for a data-driven-type processor disclosed in Japanese Patent Laying-Open No. 2002-189710.

FIG. 3 is a block diagram showing details of a delay instruction processing block 127.

FIG. 4 illustrates static analysis of a flow graph disclosed in Japanese Patent Laying-Open No. 2002-189710.

FIG. 5 is a block diagram showing a schematic configuration of a data-driven-type information processor in an embodiment of the present invention.

FIG. 6 is a block diagram showing details of a packet control unit 20 shown in FIG. 5.

FIG. 7 shows one example of a format of a data packet that flows in the data-driven-type information processor in the embodiment of the present invention.

FIG. 8 shows one example of a data flow graph.

FIGS. 9A to 9C show change over time when the data packet flows on the data flow graph shown in FIG. 8.

FIG. 10 is a data flow graph for illustrating processing in the data-driven-type information processor in the embodiment of the present invention.

FIG. 11 shows a data structure of a data packet waiting time table.

FIG. 12 shows a data structure of a data packet queue.

FIG. 13 shows change over time of the data packet output from packet control unit 20 of the data-driven-type information processor in the embodiment of the present invention.

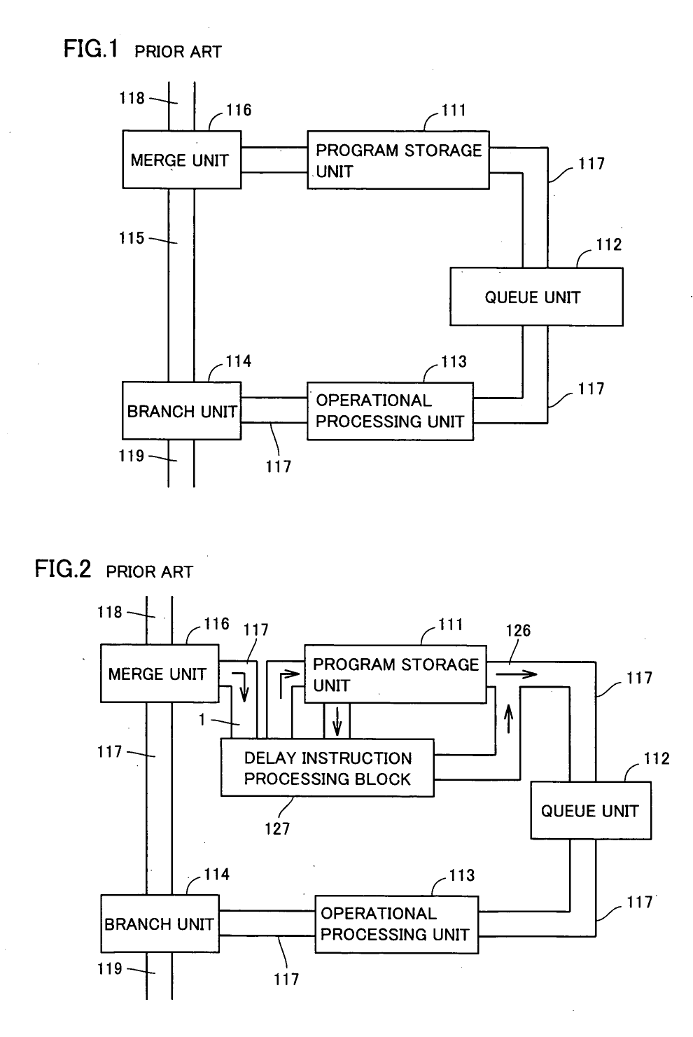

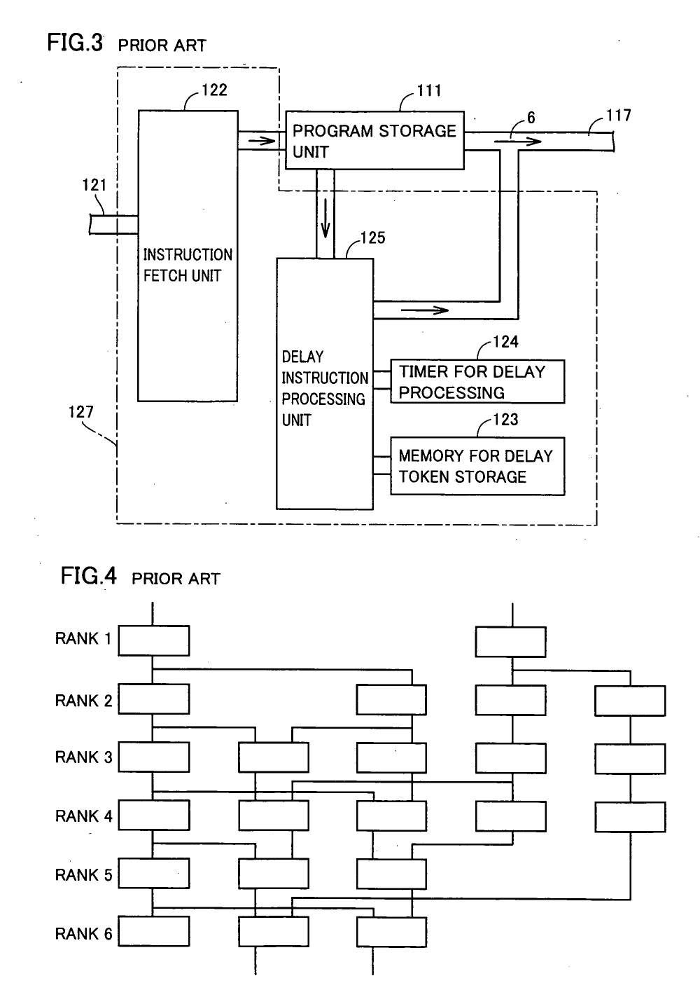

### DESCRIPTION OF THE PREFERRED EMBODIMENTS

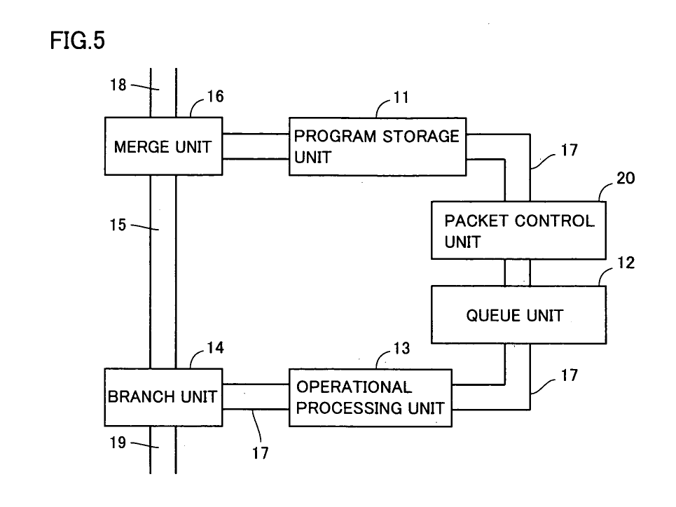

FIG. 5 is a block diagram showing a schematic configuration of a data-driven-type information processor in an embodiment of the present invention. In the data-driven-type information processor, a merge unit 16, a program storage unit 11, a packet control unit 20, a queue unit 12, an operational processing unit 13, and a branch unit 14 are connected to form a loop through a go-around pipeline 17.

Merge unit 16 rearranges data packets input through a data packet input portion 18 in a prescribed order and sends them to program storage unit 11. Program storage unit 11 adds a necessary operation instruction and a node number to the data packet received from merge unit 16, generates a data packet constituted of prescribed bit fields, and sends the data packet to packet control unit 20.

Packet control unit 20 changes an interval of output of the data packet, and sends the data packet to queue unit 12. Upon receiving the data packet from packet control unit 20, queue unit 12 waits until two data packets to be operated are ready. As soon as the data packets are ready, the data packets are sent to operational processing unit 13.

Operational processing unit 13 performs operation such as arithmetic operation or logical operation on data included in the two data packets, in response to an operation instruction included in the data packet received from queue unit 12. Thereafter, operational processing unit 13 causes a result of operation to be stored in the data packet provided with a destination node number, and sends the data packet to branch unit 14.

Branch unit 14 determines the destination in accordance with the destination node number added to the data packet received from operational processing unit 13 and distributes the data packets. Specifically, if the data packet is directed to another data-driven-type information processor, the data packet is sent through a data packet output portion 19. Alternatively, if the data packet is directed to its own data-driven-type information processor, the data packet is sent to merge unit 16 through a pipeline 15.

Though packet control unit 20 is provided between program storage unit 11 and queue unit 12 in FIG. 5, packet control unit 20 may be provided in any part of a circuit implementing the pipeline of the data-driven-type information processor.

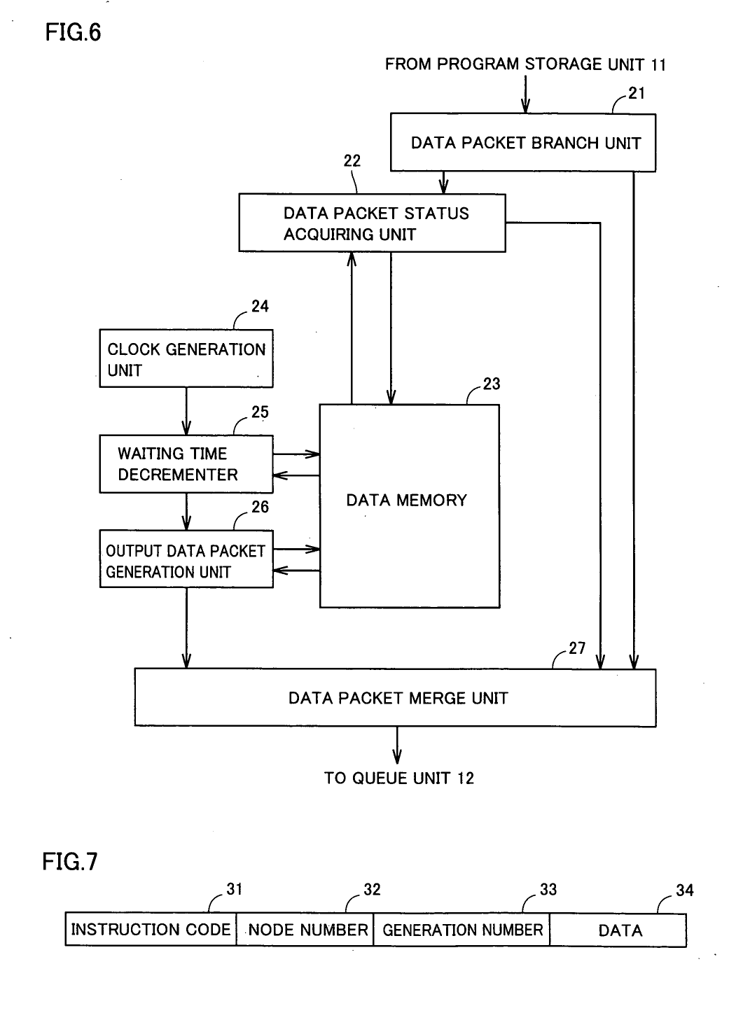

FIG. 6 is a block diagram showing details of packet control unit 20 shown in FIG. 5. Packet control unit 20 includes a data packet branch unit 21, a data packet status acquiring unit 22, a data memory 23, a clock generation unit 24, a waiting time decrementer 25, an output data packet generation unit 26, and a data packet merge unit 27. Description of a function of each unit will be provided later.

FIG. 7 shows one example of a format of a data packet that flows through the data-driven-type information processor in the embodiment of the present invention. The data packet includes an instruction code 31, a node number a generation number 33, and data 34.

Instruction code 31 represents a field in which an instruction executed in operational processing unit 13 of the data-driven-type information processor shown in FIG. 5 is expressed by a numeric value. Node number 32 indicates destination of the data packet. A next instruction is acquired from program storage unit 11 shown in FIG. 5, using node number 32 as an address.

Generation number 33 is provided for each set of data packets for which operation is performed, and it is provided for distinction between different operations even though the destination is the same. In data 34, a data value that actually goes around is stored.

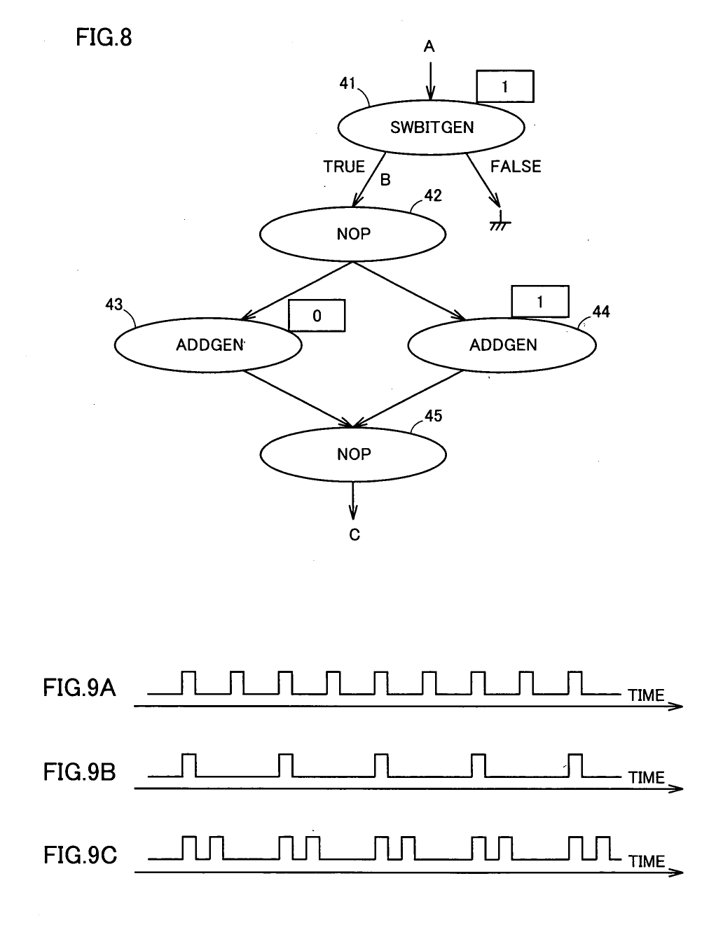

Now consider a flow graph shown in FIG. 8, as a simple example. In the flow graph, SWBITGEN (right input data value=1) 41 represents an instruction to direct the data packet to any one of a TRUE side and a FALSE side, depending on a value of generation number 33. A condition for branching is represented by the result of logical product of the value of generation number 33 and the right input data value (1 in this example). If the result of operation is 0, the data packet is output to the TRUE side. On the other hand, if the result is 1, the data packet is output to the FALSE side.

Accordingly, if the data packets, of which generation number 33 is incremented one by one, are input, the data packets are output alternately to the TRUE side and the FALSE side for each data packet. The data packet output to the FALSE side disappears, while the data packet output to the TRUE side flows to NOP 42. Namely, every other data packet among the input data packets flows to NOP 42.

Thereafter, at the output of NOP 42, the data packet is duplicated. Of these data packets resulted from duplication, with regard to the data packet that flows to ADDGEN (right input data value=0) 43, 0 is added to the value for generation number 33, that is, the data packet is output as it is. Meanwhile, with regard to the data packet that flows to ADDGEN (right input data value=1) 44, the data packet in which 1 is added to the value for generation number 33 is output. These data packets merge at NOP 45, and ultimately, the data packets are output as the data packet group in which respective data packets have generation numbers 33 incremented one by one, as in the case at the time of input.

FIGS. 9A to 9C show change over time when the data packet flows on the data flow graph shown in FIG. 8. FIG. 9A shows change over time of the data packet at an input A of SWBITGEN 41. FIG. 9B shows change over time of the data packet at an input B of NOP 42. FIG. 9C shows change over time of the data packet at an output C of NOP 45.

In FIG. 9A, the data packet is supplied at a regular interval. In FIG. 9B, as the data packets are output alternately to the TRUE side and the FALSE side in response to SWBITGEN instruction 41, the data packet is output at every other interval. In FIG. 9C, the data packet resulted from disappearance of every other data packet is duplicated, thereafter the resultant data packets are provided with generation numbers 33 incremented one by one, and the data packets merge. Therefore, generation number 33 of the data packet is set as it originally was. Turning to change over time of the data packet at output C of NOP 45, however, the data packets are output at clustered two intervals, as a result of duplication of the data packet. The output interval of the data packet can thus intentionally be changed as a result of disappearance and duplication of the data packet.

If the output interval of the data packet is set as shown in FIG. 9C and if there is processing in the data flow graph that is subsequent to NOP 45 shown in FIG. 8, it is possible that processing in the data-driven-type information processor is concentrated in a portion where output of the data packets is continuous and that overflow of the data packet instantaneously takes place, because the output interval of the data packet is not constant. Namely, the data packets cannot move on go-around pipeline 17 implemented by program storage unit 11, queue unit 12, operational processing unit 13, branch unit 14, and merge unit 16, and the entire system may stop.

In the embodiment of the present invention, the node number of NOP instruction node 45 shown in FIG. 8 is registered in advance in a register within data packet branch unit 21 shown in FIG. 6.

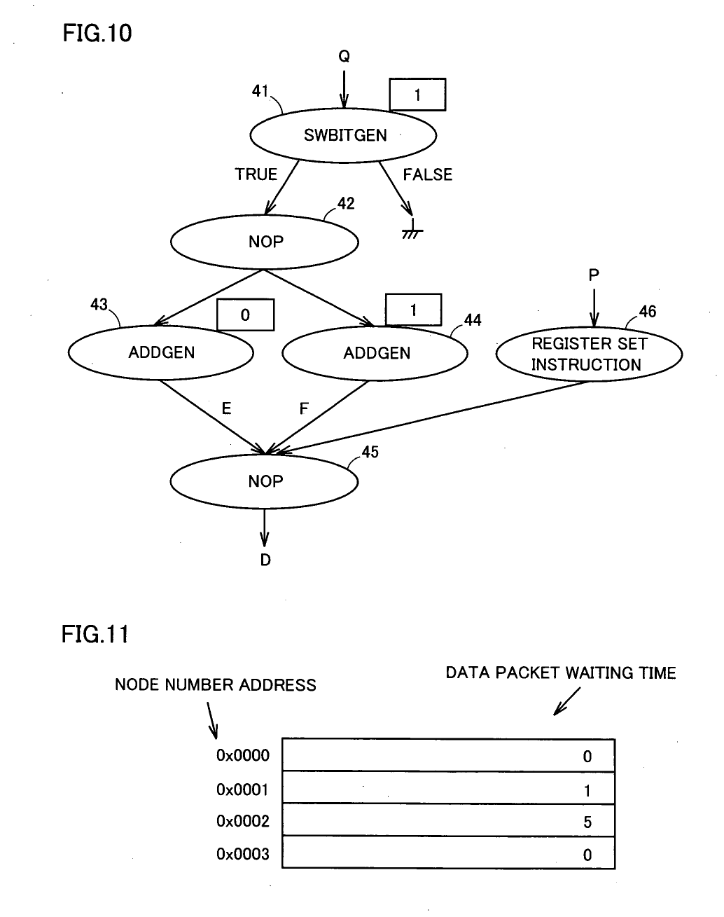

FIG. 10 is a data flow graph for illustrating processing in the data-driven-type information processor in the embodiment of the present invention. Here, one data packet having as data, a data output interval value that is desirably set flows from an input P, so that a register set instruction 46 is executed in advance.

Data packet branch unit 21 determines whether the data packet output from program storage unit 11 includes register set instruction 46 or not. If the data packet includes the register set instruction, data packet branch unit 21 stores in an internal register, destination information of the data packet, that is, the value for node number 32, as well as the data output interval value, that is, the value for data 34.

In actual processing, data packets flow from an input Q at a constant interval. When the data packets that flow through an output E of ADDGEN 43 and through an output F of ADDGEN 44 are input to data packet branch unit 21, data packet branch unit 21 compares the value in the internal register with node number 32 of the data packet. If these packets are directed to NOP instruction 45, the data packets are allowed to flow to data packet status acquiring unit 22. Data packet branch unit 21 causes other data packets to flow to data packet merge unit 27 and outputs the data packets to the outside.

Upon receiving the data packet through output E of ADDGEN 43, data packet branch unit 21 causes the data packet to flow to data packet status acquiring unit 22. Data packet status acquiring unit 22 acquires information on whether a data packet having the node number the same as that data packet has been stored in data memory 23, or had been stored or had passed several clocks before.

Data memory 23 includes a data packet waiting time table and a data packet queue. FIG. 11 shows a data structure of the data packet waiting time table. The data packet waiting time table employs the node number as the address, and the contents in the table show the waiting time of the data packet having that node number at that time point. The value of the data packet waiting time is decremented by a waiting time decrementer 25 for each clock. In addition, the data packet waiting time table is updated with a value obtained by adding the value of the data output interval to the data packet waiting time when a data packet having the address of a certain node number newly passes or is stored.

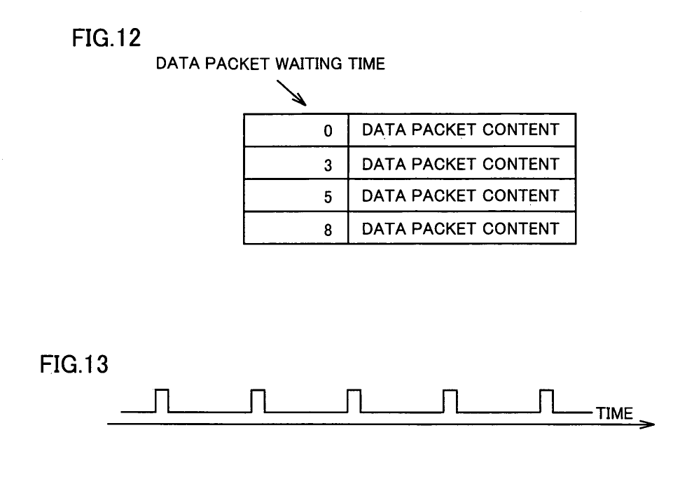

FIG. 12 shows a data structure of the data packet queue. The data packet queue is a queue for storing data packet content, and stores the waiting time for the data packet at that time point for each data packet content. The value for the data packet waiting time is decremented by waiting time decrementer 25 for each clock. The data packet waiting time within the data packet queue only decreases. When the data packet waiting time attains to 0, the data packet content is output to output data packet generation unit 26.

Data packet status acquiring unit 22 acquires the data packet waiting time to be stored in the data packet waiting time table, using the node number of the data packet as the address. The data packet waiting time indicates how long the data packet having that node number should wait in data memory 23. Though clock is used as a unit herein, any unit of time may be employed.

For example, if the data packet waiting time is set to 0, it is not necessary to store the data packet in data memory 23. Therefore, data packet status acquiring unit 22 outputs the data packet as it is to data packet merge unit 27. In addition, data packet status acquiring unit 22 acquires the data packet waiting time from the data packet waiting time table, using the node number of the data packet output to data packet merge unit 27 as the address, and adds the value of the data output interval to the data packet waiting time, so as to rewrite the value in the data packet waiting time table.

If the data packet waiting time is not set to 0, data packet status acquiring unit 22 stores the data packet content in the data packet queue, along with the data packet waiting time at that time. As the data packet is stored in the data packet queue, the value of the data packet waiting time is acquired by using the node number of that data packet as the address, and the data packet waiting time is rewritten with the value obtained by adding the data output interval value stored in the register.

Immediately after the data packet of output E of ADDGEN 43 in FIG. 10 arrives at data packet branch unit 21, the data packet of output F of ADDGEN 44 arrives at data packet branch unit 21. This is because the data packet is duplicated at a minimum interval of the pipeline, as a result of duplication operation of NOP instruction node 42 in FIG. 10.

Upon receiving the data packet of output F of ADDGEN 44, data packet branch unit 21 outputs the data packet to data packet status acquiring unit 22, because this data packet is directed to NOP instruction node 45. Data packet status acquiring unit 22 acquires information on whether a data packet having the node number the same as the data packet is currently stored, or has been stored or has passed several clocks before, by referring to data memory 23.

Specifically, data packet status acquiring unit 22 acquires the data packet waiting time from the data packet waiting time table within data memory 23, using the node number of the data packet as the address. In this case, the data packet of output E of ADDGEN 43 has passed immediately before, which means that the data packet waiting time for a period of n clocks has passed, namely, it is set to (data output interval value−n). The data packet and this value flow to data memory 23. Here, n clocks indicate the minimum interval resulted from the duplication operation.

Thereafter, data packet status acquiring unit 22 stores the value of (data output interval value−n) as the data packet waiting time in the data packet queue within data memory 23, and simultaneously also stores the data packet content.

Clock generation unit 24 constantly generates clocks, and supplies the clocks to waiting time decrementer 25. Here, any clock width may be set.

Waiting time decrementer 25 decrements all values in the data packet waiting time table in data memory 23, using the clock supplied from clock generation unit 24 as a trigger.

Similarly, waiting time decrementer 25 also decrements all values in the data packet waiting time in the data packet queue. In the data packet queue, if the value obtained as a result of decrement is 0, that address is transferred to output data packet generation unit 26.

Output data packet generation unit 26 reads the data packet content from the data packet queue, in accordance with the address transferred from the data packet queue. Then, output data packet generation unit 26 transfers the data packet content to data packet merge unit 27 as well as erases the data packet waiting time and the data packet content from the data packet queue.

Data packet merge unit 27 causes the data packets from data packet branch unit 21, data packet status acquiring unit 22 and output data packet generation unit 26 to merge, and outputs the resultant data packet.

In FIG. 10, the data packet of output E of ADDGEN 43 and the data packet of output F of ADDGEN 44 are input at a minimum interval. At a time point when the data packet of output F of ADDGEN 44 is stored in data memory 23 and the data packet waiting time attains to (data output interval value−n) and decremented to 0, the data packet is output from output data packet generation unit 26. Accordingly, the data packet of output E of ADDGEN 43 and the data packet of output F of ADDGEN 44 are output at an interval comparable to the data output interval value.

Similarly, the interval between the data packet of output F of ADDGEN 44 and the data packet of output E of ADDGEN 43 having next generation number 33 is also set to the data output interval value. In this manner, the output interval of the data packet becomes constant.

FIG. 13 shows change over time of the data packet output from packet control unit 20 of the data-driven-type information processor in the embodiment of the present invention. As shown in FIG. 13, it can be seen that the data packet group that has been output at the interval shown in FIG. 9C is output at a constant output interval.

The description above has been directed to an example in which a single register set instruction is used, however, the register set instruction may be used at a plurality of locations. In such a case, a plurality of node numbers are designated by a plurality of register set instructions. Here, the plurality of register set instructions may be ordered, so that the data packets having the same generation number can be output in a prescribed order. For example, even if data packet waiting time in the data packet queue is set to 0, output of the data packet is withheld until the data packet having a prescribed node number arrives. After the data packet having the prescribed node number arrives and a prescribed time has elapsed since output thereof, the data packet that has been waiting is output.

It is naturally permitted to output the data packet, regardless of the node number, at a time point when the data packet waiting time in the data packet queue attains to 0, without ordering the plurality of register set instructions.

Alternatively, if there is another data packet having the same destination information as a result of search in the data packet queue at a time point when the data packet waiting time in the data packet queue attains to 0, the data packet having the smallest generation number among the data packets having the same destination information may be replaced with the data packet of which data packet waiting time attains to 0, whereby the data packet having the smallest generation number is output. In this case, the value for the data packet waiting time of the data packet having the smallest generation number is set as the waiting time of the data packet of which data packet waiting time has attained to 0.

As the data output interval value is set in data 34 of the data packet input to the register set instruction, the data output interval value may be set to a different value, so as to output the data packet at a different output interval.

Alternatively, the lowest order bit of instruction code 31 may be set as a flag field for determination of a condition, so that data packet branch unit 21 outputs the data packet to data packet status acquiring unit 22 only when the flag is set to 1.

Alternatively, data packet branch unit 21 shown in FIG. 6 may be eliminated, so that all data packets are input to data packet status acquiring unit 22. In this case, data packet merge unit 27 causes the data packets output from data packet status acquiring unit 22 and output data packet generation unit 26 to merge.

Packet control unit 20 may be provided within operational processing unit 13. In this case, data packet branch unit 21 decodes instruction code 31, and if the instruction is an instruction to remain for a certain period of time, data packet branch unit 21 outputs the data packet to data packet status acquiring unit 22.

As described above, in the data-driven-type information processor in the embodiment of the present invention, the data packet waiting time is determined such that the data packet group having the same destination information is output at a prescribed interval, the data packet waiting time is stored in the data packet queue along with the data packet content, and output data packet generation unit 26 outputs the data packet content when the data packet waiting time is decremented to 0. Therefore, variation in the amount of processing of the data packet within the data-driven-type information processor is reduced, software design in which margin is reduced almost to the limit of processing performance of the data-driven-type information processor even in static analysis can be made, and the processing performance of the data-driven-type information processor can be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data-driven-type information processor performing operational processing along with input/output of a data packet, comprising:
a control unit determining a waiting time required for said data packet when said data packet is included in a data packet group of which output at a prescribed interval is demanded and outputting said data packet when the waiting time has elapsed; and
an operational processing unit performing operational processing in response to an operation instruction included in said data packet.

2. The data-driven-type information processor according to claim 1, wherein
said control unit includes
a branch unit determining whether said data packet is included in the data packet group of which output at the prescribed interval is demanded and distributing said data packet in accordance with a result of determination,
an acquiring unit acquiring historical information of another data packet included in said data packet group when said data packet is included in the data packet group of which output at the prescribed interval is demanded and determining the waiting time of said data packet,
a storage unit storing the waiting time determined by said acquiring unit,
an output portion outputting said data packet when the waiting time stored in said storage unit has elapsed, and
a merge unit causing the data packet that has been determined by said branch unit as not included in the data packet group of which output at the prescribed interval is demanded, the data packet that has been determined by the acquiring unit as not having to wait, and the data packet output from said output portion, to merge.

3. The data-driven-type information processor according to claim 1, wherein
said data packet group refers to a plurality of data packets containing identical destination information.

4. The data-driven-type information processor according to claim 3, wherein
said branch unit holds the destination information included in a data packet containing a prescribed instruction in a register, and determines whether the data packet is included in said data packet group, based on whether the destination information of said data packet is identical to the destination information held in said register.

5. The data-driven-type information processor according to claim 4, wherein
said prescribed interval is included in the data packet containing said prescribed instruction.

6. The data-driven-type information processor according to claim 1, wherein
said prescribed interval is a constant interval.

7. The data-driven-type information processor according to claim 2, wherein
if there are a plurality of data packet groups, said output portion outputs said plurality of data packet groups in a prescribed order.

8. The data-driven-type information processor according to claim 2, wherein
said output portion outputs data packets included in said data packet group sequentially from a data packet having a smaller generation number.

9. The data-driven-type information processor according to claim 2, wherein
said data packet includes a flag indicative of whether said data packet is included in the data packet group of which output at the prescribed interval is demanded, and
said acquiring unit determines whether said data packet is included in the data packet group of which output at the prescribed interval is demanded, by referring to said flag.

10. A method of controlling a data-driven-type information processor performing operational processing along with input/output of a data packet, comprising the steps of:
determining a waiting time required for said data packet when said data packet is included in a data packet group of which output at a prescribed interval is demanded and outputting said data packet when the waiting time has elapsed; and
performing operational processing in response to an operation instruction included in said data packet.

11. The method of controlling a data-driven-type information processor according to claim 10, wherein
said step of determining a waiting time and outputting said data packet includes the steps of
determining whether said data packet is included in the data packet group of which output at the prescribed interval is demanded and distributing said data packet in accordance with a result of determination,
acquiring historical information of another data packet included in said data packet group when said data packet is included in the data packet group of which output at the prescribed interval is demanded and determining the waiting time of said data packet,
storing said determined waiting time,
outputting said data packet when said stored waiting time has elapsed, and
causing the data packet that has been determined as not included in the data packet group of which output at the prescribed interval is demanded, the data packet that has been determined as not having to wait, and output said data packet, to merge.
